(19) United States
(12) Patent Application Publication
(10) Pub. No.: US 2006/0184463 A1
(43) Pub. Date: Aug. 17, 2006

(54) Visual representation tool for course of action planning

(75) Inventors: Robert Cook, San Francisco, CA (US); Patrick Tufts, Berkeley, CA (US); Terence Ryan, San Francisco, CA (US); Tomi Pierce, San Rafael, CA (US); W. Daniel Hillis, Encino, CA (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Northrop Grumman Corporation

(21) Appl. No.: 11/013,781

(22) Filed: Dec. 16, 2004

(51) Int. Cl. G06F 15/18

(52) U.S. Cl. 706/14

(57) ABSTRACT

Systems and methods are provided for evaluating a plurality of courses of action according to a plurality of decision factors. A system memory contains a decision model comprising a plurality of global influence values and the plurality of courses of action. Each course of action has an associated set of decision parameters corresponding to the plurality of decision factors. An input device is operative to receive input from a user to adjust the values of the global influence values. A computational engine calculates a fitness parameter for each course of action based on the set of decision parameters for the course of action and the global influence values. The computational engine is operative to update the decision model in real time to reflect input from the user interface. A display displays the decision model to the user.

### RELATED APPLICATION

The present application is related to co-pending application Ser. No. 10/647,949 filed Aug. 26, 2003 entitled “Visual Representation Tool For Structured Arguments”.

### TECHNICAL FIELD

The present invention relates to assisted decision making applications and, more particularly, to a visual representation tool for selecting among a plurality of available courses of action.

### BACKGROUND OF THE INVENTION

In the past, decisions frequently had to be made on minimal amounts of available data. Information traveled slowly, and what information was available could be considered by a human mind. Frequently, the greatest problem facing a decision maker was a paucity of information. Advances in information gathering. and transmittal technologies have reversed this trend, making it easier to gather large amounts of information pertaining to a particular problem. A major task facing modern day decision makers is filtering and organizing the received information into a useful form.

While automated classification and decision making systems have become increasingly sophisticated, the human mind still outperforms automated systems on most real-world tasks. A limitation of human decision making, however, is the inability of human beings to simultaneously consider a large number of factors. Decision makers often find it difficult to mentally combine large amounts evidence since the human tendency is to postpone risky decisions when data is incomplete, jump to conclusions, or refuse to consider conflicting data. Accordingly, automated methods of organizing and displaying data can greatly aid human decision makers.

### SUMMARY OF THE INVENTION

In accordance with one aspect of the invention, a system is provided for evaluating a plurality of courses of action according to a plurality of decision factors. A system memory contains a decision model comprising a plurality of global influence values and the plurality of courses of action. Each course of action has an associated set of decision parameters corresponding to the plurality of decision factors. An input device is operative to receive input, from a user to adjust the values of the global influence values. A computational engine calculates a fitness parameter for each course of action based on the set of decision parameters for the course of action and the global influence values. The computational engine is operative to update the decision model in real time to reflect input from the user interface. A display displays the decision model to the user.

In accordance with another aspect of the invention, a computer program product, located on a computer readable medium and operative in a data processing system, is provided for analyzing a plurality of courses of action according to a plurality of decision factors. A decision model comprises the plurality of courses of action and a plurality of global influence values. Each course of action has a set of decision parameters corresponding to the plurality of decision factors. A user interface allows a user to alter decision parameters and influence values within the decision model. A computational engine calculates a fitness value associated with each course of action based on the decision parameters for the course of action and the global influence values. The computational engine updates the decision model in real time to reflect input from the user interface.

In accordance with another aspect of the invention, a method is provided for determining the sensitivity of a decision model to a decision factor of interest. A set of decision parameters, corresponding to a plurality of decision factors, is determined for each of a plurality of courses of action. An initial set of global influence values for the decision model is selected. Each of the initial global influence values corresponding to one of the plurality of decision factors. An initial fitness value is calculated for each course of action according to the set of decision parameters. One of the global influence values corresponding to the decision factor of interest is altered. New fitness values for the plurality of courses of action are calculated in real time in response to the altered global influence value.

### BRIEF DESCRIPTION OF THE DRAWINGS

FIG. 1 illustrates a system for displaying and evaluating a plurality of available courses of action in accordance with one aspect of the invention.

FIG. 2 illustrates an exemplary system for collaborative evaluation of a plurality of courses of action for addressing a situation of interest in accordance with one aspect of the present invention.

FIG. 3 illustrates a first display from an exemplary course of action analyzer in accordance with one aspect of the present invention.

FIG. 4 illustrates a second display from an exemplary course of action analyzer in accordance with one aspect of the present invention.

FIG. 5 illustrates an exemplary log function associated with a course of action from a decision model in accordance with one aspect of the present invention.

FIG. 6 illustrates a methodology for determining the sensitivity of a decision model to one of a plurality of decision factors in accordance with one aspect of the invention.

FIG. 7 illustrates a computer system that can be employed to implement systems and methods described herein.

### DETAILED DESCRIPTION OF INVENTION

The present invention relates to systems and methods for analyzing a plurality of available courses of action in a manner easily comprehensible to a human being. The present invention has broad applicability to decision making in circumstances where evidence is uncertain, incomplete, and possibly conflicting. The present invention provides a graphical display of a decision model including a plurality of courses of action, characteristics associated with each of the courses of action, and influence values representing the influence of a given characteristic on the fitness of a course of action. The decision model can be edited by a user with real time updates to the model and as well as fitness values associated with the courses of action. This allows a user to immediately see the impact of any change of the influence values.

It will be appreciated that the present invention can be employed in any decision making applications in which multiple courses of action are considered. The systems and methods of the present invention can be applied to applications ranging from high-level government policy to procurement decisions in a small business. Thus, while the exemplary embodiments illustrated within this application focus on military and defense applications, the present invention can be applied in other fields, such as industrial processes, design work, research, and corporate management.

One application of the real time updating of the decision model is sensitivity analysis. Since the displayed model is updated in real time, it is possible to adjust the confidence of a particular hypothesis and view the effect on the fitness of the various course of action. A given decision can be based upon a large number of relevant factors. Therefore, the ability to graphically display the effects of dynamic changes within the importance of these factors allows a user to evaluate the value of each proposed course of action in light of changing circumstances.

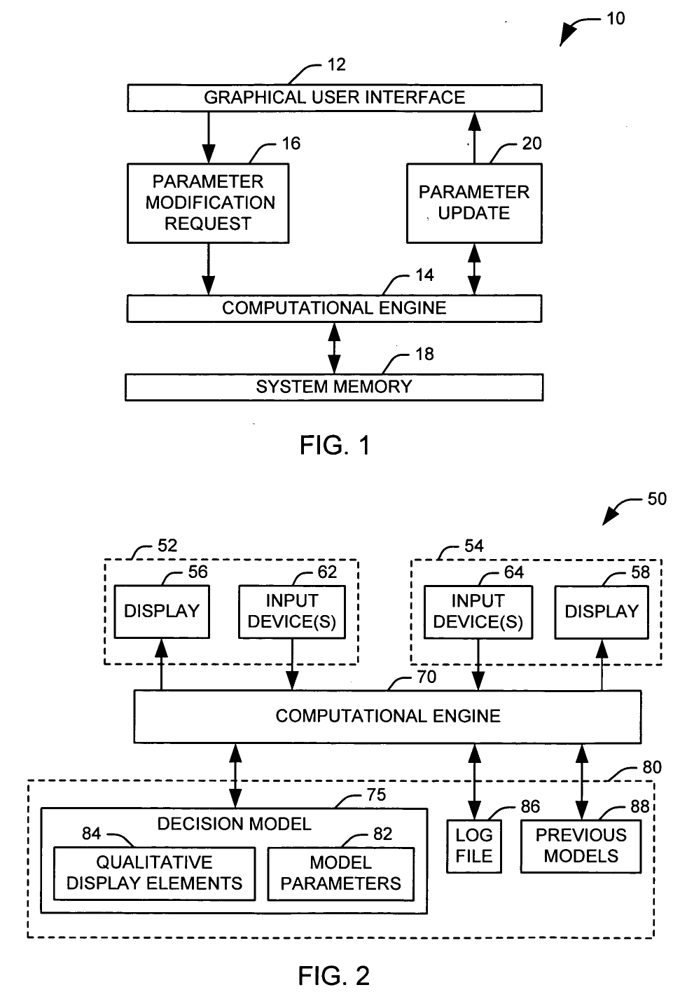

FIG. 1 illustrates a system 10 for displaying and evaluating a plurality of available courses of action. The illustrated system 10 allows a user to explore the sensitivity of a given course of action to a plurality of associated decision factors and display the results of the sensitivity analysis in real time. A graphical user interface (GUI) 12 displays a plurality of available courses of actions to a user. The available courses of action can be displayed in any fashion easily comprehensible to a user, but in an exemplary implementation, a course of action can be displayed as a series of tasks associated with the course of action arranged in an expected chronological order for the tasks.

Each course of action has a plurality of associated decision parameters associated with the decision factors. The decision parameters quantify various advantages and disadvantages, represented by the decision factors, for a given course of action. For example, the decision parameters could represent the cost of a given plan of action, the probability of success, and/or the perceived benefits of the plan. The decision parameters can vary along any reasonable number scale that allows for a sufficient expression of differences between the various courses of action.

The GUI 12 also displays a plurality of global influence values corresponding to the plurality of decision factors. The global influence values control the influence of each decision factor in determining an overall fitness for a plan of action. A computational engine 14 associated with the GUI 12 can utilize these global influence values and the decision parameters associated with each course of action to calculate a fitness parameter for each course of action. An appropriate course of action can be selected based upon these fitness parameters.

The graphical user interface 12 is also operative to accept input from the user requesting the modification of global influence values and the decision parameters associated with individual course of action. In an exemplary embodiment, the value of each decision parameter and global influence value can be changed by moving an associated slider. In response to the user input, a parameter modification request 16 is provided to the computational engine 14. The computational engine 14 updates the fitness values associated with the courses of action in response to the modification request 16. For example, if the modified parameter is a decision parameter associated with one course of action, the parameter is altered in a system memory 18, and a new fitness value is calculated for the course of action according to the modified parameter and the global influence values. If the modified parameter is an influence value, a new fitness value can be calculated for each of the course of action in light of the new influence value.

The updated parameter values are provided to the graphical user interface 12 as a parameter update 20. The graphical user interface 12 updates the values of the parameters on the screen to reflect the modified parameter as well as any modifications to the fitness values of the courses of action. The display can be changed not only to shown the revised figures, but qualitative aspects of the display can be changed as well to reflect the revised figures. For example, the color or brightness of an indicator associated with a given course of action can be changed to reflect its fitness value. It will be appreciated that these updates are calculated at the computational engine 14 and provided to the graphical user interface 12 at a high rate of speed. Thus, the display can be modified by the graphical user interface 12 in real time to immediately show the user the results of the modifications. This allows a user to determine the sensitivity of the various courses of actions to any changes in the decision parameters or influence values.

In an exemplary embodiment, each of the tasks in a given course of action can be assigned values related to the various influence factors. For example, if one of the influence values in required manpower, each task can be assigned a value estimating the required manpower for the task in hours. A decision parameter associated with the manpower factor for the course of action can be determined as a function of the sum of these manpower values. In another embodiment, the various tasks can be assigned decision parameters of their own, and the course of action can be represented in a belief network form. The decision parameter values for the various tasks can be interrelated, such that the value of a given decision parameter for a course of action can be determined from the values for the decision parameter for the plurality of associated tasks. For example, the tasks can be arranged hierarchically, such that tasks lower in the hierarchy influence tasks above them in the hierarchy. The tasks can be linked between levels of the hierarchy with to quantify the contribution of each lower level task with one or more corresponding higher level tasks. A weight value for a given link can be established to weight the contribution from each task, with the value of the decision parameter at a task being a function of the weighted contributions of lower level tasks.

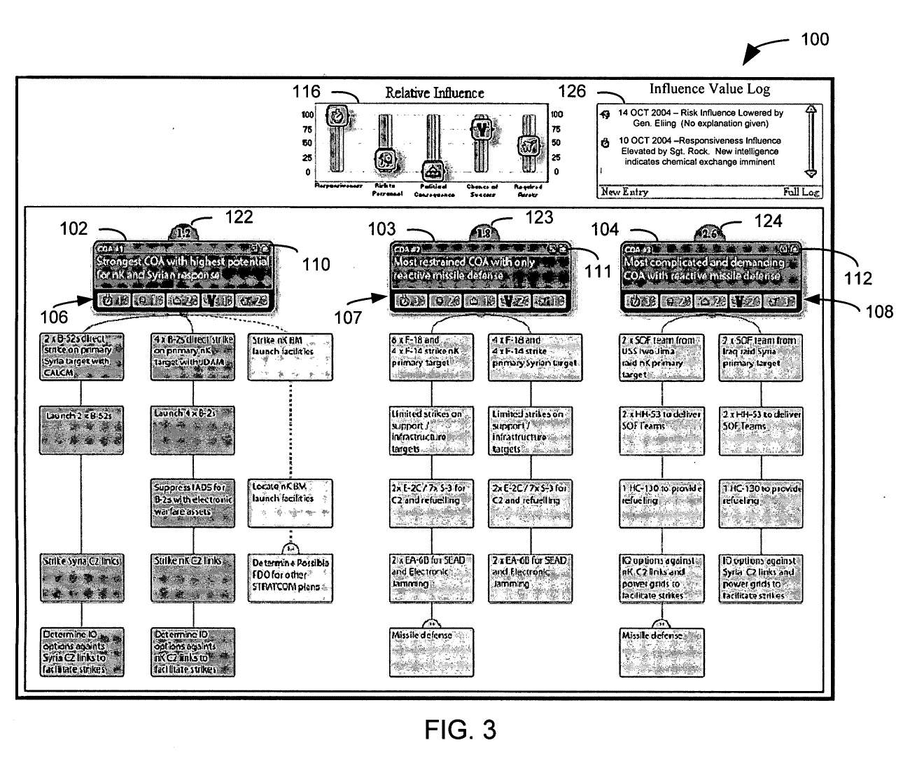

FIG. 2 illustrates an exemplary system 50 for collaborative evaluation of a plurality of courses of action for addressing a problem of interest in accordance with one or more aspects of the present invention. The illustrated system 50 allows multiple users to access and manipulate a model, comprising a plurality of courses of action, for addressing the problem of interest. The system 50 comprises a plurality of user interfaces 52 and 54 that allow users to view and edit the model. It will be appreciated that the user interfaces 52 and 54 can be located remotely from the other components of the system 50 and from one another. The user interfaces 52 and 54 can each comprise a display 56 and 58 and one or more input devices 62 and 64. For example, users can utilize an input device (e.g., 62) to provide edit commands to a computational engine 70. The computational engine 70 is operative to edit one or more parameters and characteristics associated in a decision model 75 stored in an associated system memory 80.

When a parameter within the model is changed, the computational engine 70 updates fitness parameters for the courses of action within the model according to an associated formula. In one implementation, the fitness parameters for each course of action are determined as a weighted average of the decision parameters associated with the course of action. The weights for each decision parameter can be determined from the global influence values. For example, a given weight can be determined as the ratio of a given influence value to the sum of all the influence values. The updated fitness parameters can stored as model parameters 82 in the decision model 75. Qualitative aspects of the model stored in memory 84 can also be changed in response to the changed parameters. For example, the color, brightness, or line thickness of a box associated with a course of action can be changed to reflect an updated fitness value. Similarly, the brightness, size, or thickness of the displayed decision parameters can be altered as their associated global influence values are increased or decreased.

In addition, a log file 86 associated with the decision model 75 can be updated to reflect the change of a global influence value or a decision parameter. The log file 86 can contain a record of each parameter change, the time and date of the change, the identity of the user making the change, and a rationale for the change. This allows a collaborative review of the decision model 75 by a number of experts while maintaining accountability for changes to the model. For example, if one of the decision parameters represents a cost of a given plan of action, a first expert, knowledgeable about the expense associated with the tasks comprising a given course of action, can adjust the value for this decision parameter for each course of action. A second expert can determine the probability of success for each course of action and adjust another parameter for each course of action. A supervisor can then determine the importance of each of these parameters and adjust the global influence parameters accordingly. Each of these actions, and the rationale for the change, can be recorded in the log file 86. Once the decision model 75 and the log file 86 have been updated, the updated data is displayed to the users at the displays 56 and 58. It will be appreciated that the update data can include updated fitness parameters, decision parameters, global influence values, log file entries, and qualitative changes to the display.

A user can also add, remove, or edit one or more tasks associated with a course of action through the user interface (e.g., 62). The decision parameters associated with the amended course of action can be altered in response to these changes. To assist with building a decision model, previous decision models 88, containing related courses of action, can be retrieved from the memory 75 and displayed at the user's display (e.g., 54). It will be appreciated that at any time, the system is used by a plurality of users, and that decision models constructed by any user, past or present, can be stored within the system memory. Accordingly, the experience of a large number of users can be drawn upon through the stored models 88.

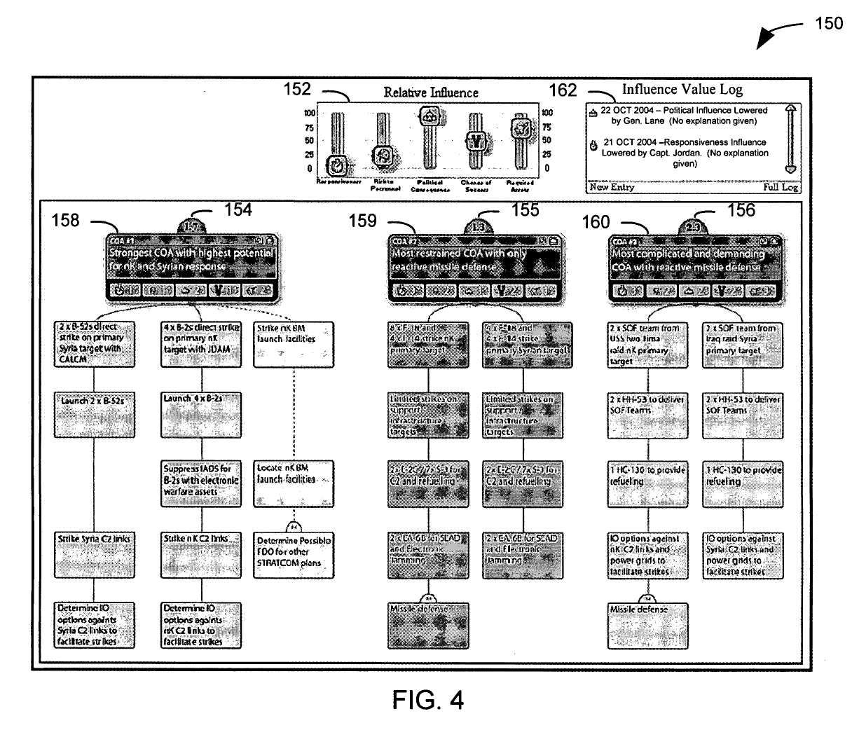

FIGS. 3 and 4 illustrate the use of an exemplary implementation of the invention in a sensitivity analysis of a plurality of course of actions to one or more decision factors. FIG. 3 illustrates a first display 100 from an exemplary course of action analyzer in accordance with one or more aspects of the present invention showing a main screen view of a decision model comprising a plurality of courses of action 102-104. The illustrated display 100 illustrates the courses of action 102-104 when the influence values for the decision factors are set at a first state. In an exemplary military implementation, the decision factors include the responsiveness of a course of action (e.g., necessary time to implement the course of action), the risk to personnel, the political consequences, the likelihood of success, and the required assets for the course of action.

In the illustrated display 100, respective sets of decision parameters 106-108 for each course of action 102-104, corresponding to the decision factors, have been set according to the characteristics of each course of action. In the illustrated example, these values can be set to integer values ranging from one to three by one or more human analysts. It will be appreciated that other number scales can be utilized within a decision model according to the preferences of the one or more analysts constructing the model. Each of the courses of action 102-104 has an associated log file, accessible via respective log file icons 110-112. Whenever a value is set or altered within a given course of action, an entry can be added to the associated log reflecting the new value, the time and date at which the new value was entered, the identity of the individual adding the new value, and a rationale for the value. A given log can be expanded for viewing or collapsed back into the course of action using the associated log icon (e.g., 110).

The relative influence of the various decision factors can be changed at a set of influence sliders 116. A user can adjust a given influence slider to increase or decrease the importance of a given decision factor relative to the other factors. As the influence values are changed, fitness parameters 122-124 associated with the plurality of courses of action 102-104 are adjusted in real time to reflect the changed influence values. For example, a fitness value for a course of action can be calculated as a weighted average of the decision parameters associated with the course of action, with the weights determined from the influence values. Qualitative aspects of the display, such as the brightness, color, or size of a given course of action, can also be made in response to the changed influence values. For example, in the illustrated display, the first course of action has the best (e.g., smallest) fitness value, and is displayed in a brighter shade than the other courses of actions.

The user can experiment with various settings to determine the sensitivity of the courses of action to each decision factor. When the user selects a value for a given influence value, the user can be prompted for a rationale for the selection. The value, the rationale, the time and date at which the value was set, and the identity of the user can be recorded in an associated influence value log 126. The influence value log 126 and the logs associated with the course of action simplify collaboration between multiple users, allowing each user to understand the source of values within the decision model.

FIG. 4 illustrates a second display 150 from an exemplary course of action analyzer in accordance with one or more aspects of the present invention showing a main screen view of the decision model after one or more influence values 152 associated with the model have been changed. In the illustrated example, the influence of the responsiveness factor has been sharply lowered, the influence of political factors has been sharply increased, the influence of the required assets factor has been raised slightly, and influence of the likelihood of success has been lowered slightly. As a result, the fitness parameters 154-156 associated with the plurality of courses of action 158-160 and various qualitative aspects of the display have been changed to reflect the new influence values. In addition, the log file 162 associated with the decision model has been changed to record the changes to the influence parameters.

For example, the fitness parameter 154 associated with the first course of action has increased to 1.7 from its value of 1.3 in FIG. 3, reflecting the larger influence of the political consequence and required assets factors. Similarly, the fitness parameter of the second course of action has decreased from 1.8 to 1.2, reflecting the decreased influence of the responsiveness and chance of success factors. In the illustrated example, the brightness of the background of the second course of action is increased to reflect the fact that the second course of action now has the best fitness parameter at 1.2. The brightness of the first course of action is decreased to indicate that it is no longer the most viable course of action, given the current state of the influence parameters. Accordingly, an analyst can quickly see the effects of a change in the influence of a decision factor, allowing the analyst to plan in advance for any changes in the real world parameters of the problem of interest.

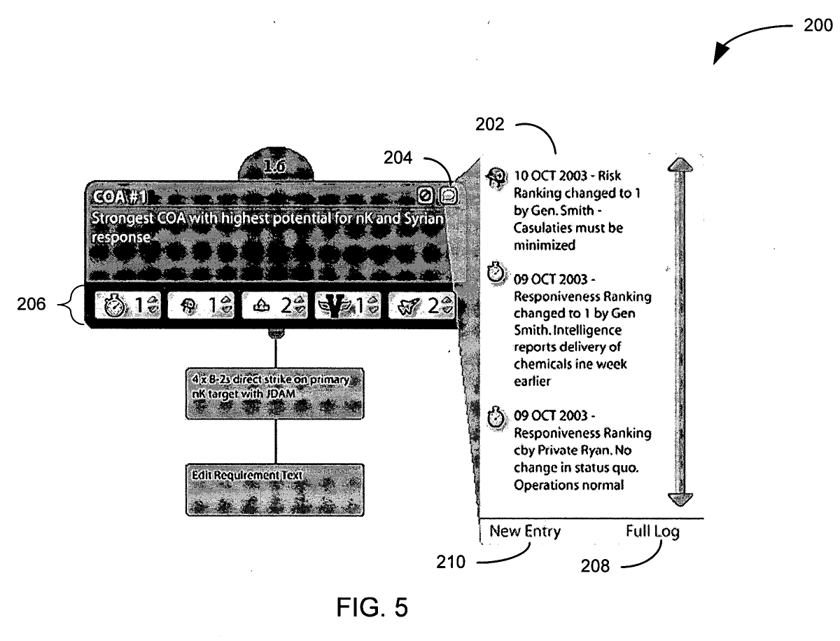

FIG. 5 illustrates an exemplary log function associated with a course of action 200 from a decision model in accordance with an aspect of the present invention. In the illustrated example, the parameter log 202 has been expanded from the log icon 204 associated with the course of action. The parameter log 202 contains a plurality of entries listing each change to the decision parameters 206 associated with the course of action, the identity of the user making the change, the time and date of the change, and a rationale for the change. The log function thus allows a user to understand the reasoning behind a given parameter value, and facilities communication between the various users of the decision model.

The parameter log 202, in the main screen view, shows only a few of the most recent changes. The complete log of all changes to the parameters 206 can be viewed by selecting a full log option 208 located at the bottom of the parameter log 202. The full log 208 can be opened as a subsidiary window separate from the main screen view illustrated in FIG. 5. Additional log entries can be added using a new entry option 210 located at the bottom of the parameter log. For example, the new entry option 210 can be used to add a log entry explaining a change to a decision parameter. The user can collapse the parameter log 202, including the new entry option 210 and the full log option 208, back into the course of action 200 by selecting the log icon 204 again, allowing an unobstructed view of the full decision model.

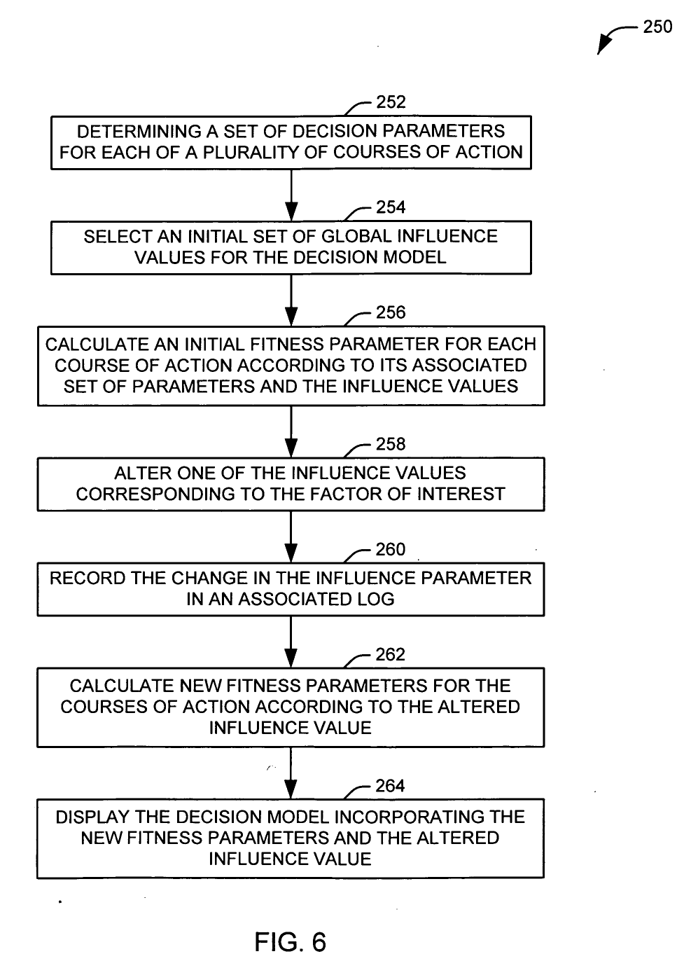

In view of the foregoing structural and functional features described above, methodologies in accordance with various aspects of the present invention will be better appreciated with reference to FIG. 6. While, for purposes of simplicity of explanation, the methodologies of FIG. 6 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 6 illustrates a methodology 250 for determining the sensitivity of a decision model to one of a plurality of decision factors. The decision model can include a plurality of courses of action, each comprising a plurality of associated tasks. The methodology 250 begins at 252, where a set of decision parameters, corresponding to the plurality of decision factors, is determined for each of the courses of action. Each decision parameter represents the desirability of the course of action evaluated solely on the basis of the associated decision factor. For example, if the decision factor is a cost of the course of action, a course of action having a low cost can be assigned a value representing the more desirable end of the scale of possible parameter values. The specifics of the scale can vary depending on the configuration of the decision model. The decision parameters can be set by one or more human users of the decision model or calculated from values associated with the tasks comprising the course of action. In an exemplary implementation, each task in a given can be assigned an estimated cost in U.S. dollars. A cost parameter for the course of action can be assigned as a function of the sum of the costs of its associated tasks.

At 254, an initial set of global influence values, corresponding to the plurality of decision factors, are selected by one or more users of the decision model. The influence parameters represent the relative influence of each of the decision factors on the decision model. Accordingly, as a value is increased, the influence of its associated decision factor is increased, and the influence of the other decision factors is decreased proportionally. It will be appreciated that the decision model can be a collaborative effort, such that the influence values and the decision parameters associated with the courses of actions can be selected by different users.

At 256, an initial influence value is calculated for each of the courses of action as a function of the global influence values and the associated decision parameters of the course of action. For example, weight values for each decision factor can be determined from the global influence values as the ratio of the influence value associated with the decision factor to the sum of the influence values. Using these weights, the fitness parameters for each course of action can be calculated as the weighted sum of the parameters for each course of action. Qualitative aspects of the display can be configured to recognize the course of action having the most desirable fitness parameter. For example, an object representing the best course of action can be displayed with a different brightness, color, shape, or size relative to the other courses of action.

At 258, one of the global influence values is altered. For example, a user can move a slider on a graphical user interface that is associated with the influence value to produce a new value. The change in the influence value can be recorded in a log at 260 to facilitate collaboration on the decision model. New fitness values can be calculated for the courses of action at 262, reflecting the changed global influence value. For example, new weights can be calculated for the decision factors from the new influence values, and the weighted sum of each course of action can be determined to produce a new fitness parameter for each course of action.

The decision model can then be displayed to the user at 264, reflecting the change in the influence values and the fitness parameters. This can include not only changes to the displayed fitness parameters, but also qualitative changes to the display reflecting any change in the relative fitness of the courses of action. For example, objects representing the courses of action can change in brightness, size, or color as the fitness value changes. In another example, the object representing the best course of action can be displayed with a different brightness, color, shape, or size relative to the other courses of action, and the selected object can change dynamically with the change in influence value. It will be appreciated that the recalculation of the fitness parameters and the display of the adjusted model can be accomplished in real time, allowing a user to graphically observe the sensitivity of the model to the altered parameter as it is changed.

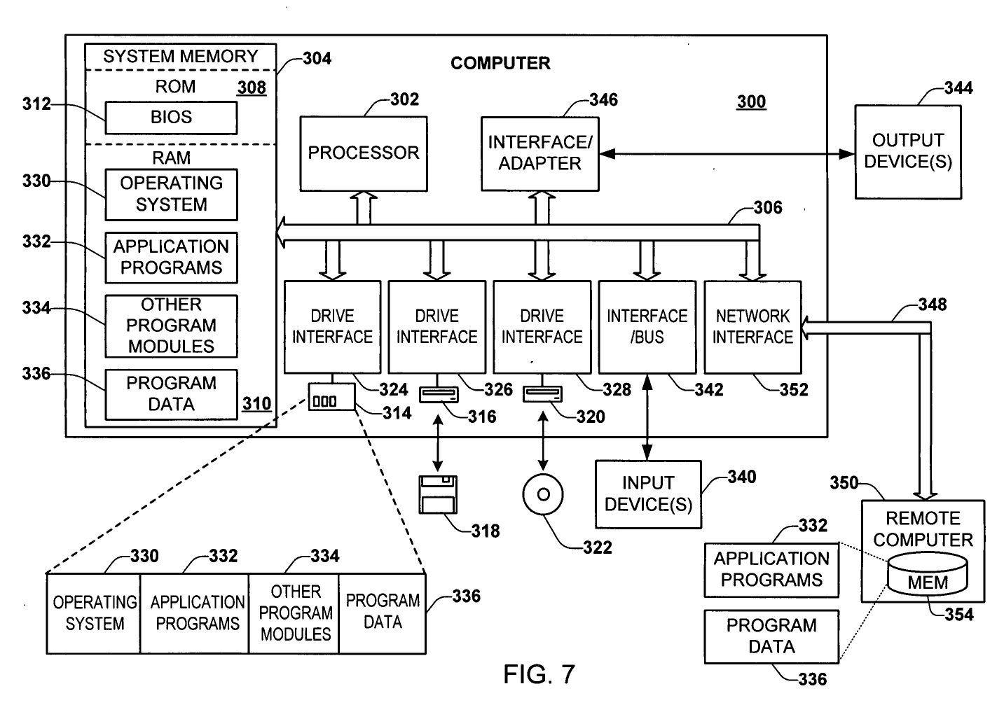

FIG. 7 illustrates a computer system 300 that can be employed to implement systems and methods described herein, such as based on computer executable instructions running on the computer system. The computer system 300 can be implemented on one or more general purpose networked computer systems, embedded computer systems, routers, switches, server devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. A system bus 306 couples various system components, including the system memory 304 to the processor 302. Dual microprocessors and other multi-processor architectures can also be utilized as the processor 302. The system bus 306 can be implemented as any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) 312 can reside in the ROM 308, generally containing the basic routines that help to transfer information between elements within the computer system 300, such as a reset or power-up.

The computer system 300 can include a hard disk drive 314, a magnetic disk drive 316, e.g., to read from or write to a removable disk 318, and an optical disk drive 320, e.g., for reading a CD-ROM or DVD disk 322 or to read from or write to other optical media. The hard disk drive 314, magnetic disk drive 316, and optical disk drive 320 are connected to the system bus 306 by a hard disk drive interface 324, a magnetic disk drive interface 326, and an optical drive interface 334, respectively. The drives and their associated computer-readable media provide nonvolatile storage of data, data structures, and computer-executable instructions for the computer system 300. Although the description of computer-readable media above refers to a hard disk, a removable magnetic disk and a CD, other types of media which are readable by a computer, may also be used. For example, computer executable instructions for implementing systems and methods described herein may also be stored in magnetic cassettes, flash memory cards, digital video disks and the like.

A number of program modules may also be stored in one or more of the drives as well as in the RAM 310, including an operating system 330, one or more application programs 332, other program modules 334, and program data 336.

A user may enter commands and information into the computer system 300 through user input device 340, such as a keyboard, a pointing device (e.g., a mouse). Other input devices may include a microphone, a joystick, a game pad, a scanner, a touch screen, or the like. These and other input devices are often connected to the processor 302 through a corresponding interface or bus 342 that is coupled to the system bus 306. Such input devices can alternatively be connected to the system bus 306 by other interfaces, such as a parallel port, a serial port or a universal serial bus (USB). One or more output device(s) 344, such as a visual display device or printer, can also be connected to the system bus 306 via an interface or adapter 346.

The computer system 300 may operate in a networked environment using logical connections 348 to one or more remote computers 350. The remote computer 348 may be a workstation, a computer system, a router, a peer device or other common network node, and typically includes many or all of the elements described relative to the computer system 300. The logical connections 348 can include a local area network (LAN) and a wide area network (WAN).

When used in a LAN networking environment, the computer system 300 can be connected to a local network through a network interface 352. When used in a WAN networking environment, the computer system 300 can include a modem (not shown), or can be connected to a communications server via a LAN. In a networked environment, application programs 332 and program data 336 depicted relative to the computer system 300, or portions thereof, may be stored in memory 354 of the remote computer 350.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. An assisted decision making system, comprising:
a system memory containing a decision model comprising a plurality of global influence values and a plurality of courses of action, each course of action having an associated set of decision parameters corresponding to a plurality of decision factors;
an input device, operative to receive input from a user to adjust the values of the global influence values; and
a computational engine that calculates a fitness parameter for each course of action based on the set of decision parameters for the course of action and the global influence values, the computational engine being operative to update the decision model in real time to reflect input from the user interface.

2. The system of claim 1, further comprising a display that displays the decision model to the user.

3. The system of claim 2, the system memory further containing a plurality of stored decision models that can be viewed by the user at the display.

4. The system of claim 2, further comprising a second input device and a second display, the second input device and the second display being located remotely from the first input device and the first display.

5. The system of claim 2, the displayed decision model including qualitative aspects relating to the calculated fitness parameters, the computational engine being operative to update the qualitative aspects of the display in response to a change in the global influence values.

6. The system of claim 1, the system memory containing a log file that records changes to the global influence values.

7. The system of claim 1, wherein each course of action comprises a plurality of tasks, each of the plurality of tasks having an associated parameter related to one of the plurality of decision factors, at least one decision parameter from the set of decision parameters for each course of action being determined from the associated parameters of the plurality of tasks associated with the course of action.

8. A computer readable medium having computer executable instructions for analyzing a plurality of courses of action according to a plurality of decision factors, the computer readable medium comprising:
a decision model, comprising the plurality of courses of action and a plurality of global influence values, each course of action having a set of decision parameters corresponding to the plurality of decision factors;
a user interface that allows a user to alter decision parameters and influence values within the decision model; and
a computational engine that calculates a fitness value associated with each course of action based on the decision parameters for the course of action and the global influence values, the computational engine updating the decision model in real time to reflect input from the user interface.

9. The computer readable medium of claim 8, further comprising a log file that records changes in the influence values and the decision parameters.

10. The computer readable medium of claim 8, further comprising a plurality of stored decision models that can be accessed through the user interface.

11. The computer readable medium of claim 8, the computational engine updating qualitative aspects of the decision model based on the calculated fitness values.

12. The computer readable medium of claim 11, the qualitative aspects of the decision model including the relative brightness of a plurality of objects displayed at the user interface that represent the plurality of courses of action.

13. A method for determining the sensitivity of a decision model to a decision factor of interest, comprising:
determining a set of decision parameters, corresponding to a plurality of decision factors, for each of a plurality of courses of action;
selecting an initial set of global influence values for the decision model, each of the initial global influence values corresponding to one of the plurality of decision factors;
calculating an initial fitness value for each course of action according to the set of decision parameters;
altering one of the global influence values corresponding to the decision factor of interest; and
calculating new fitness values for the plurality of courses of action in real time in response to the altered global influence value.

14. The method of claim 13, further comprising displaying the new fitness values and objects representing their associated courses of action to at least one user in real time.

15. The method of claim 14, wherein displaying the new fitness values to at least one user comprises displaying qualitative changes to the objects representing the courses of action.

16. The method of claim 13, further comprising recording the alteration of the global influence value in an associated log.

17. The method of claim 13, wherein determining a set of decision parameters for each of the courses of action includes accepting input from a first user, and selecting an initial set of global influence values for the decision model includes accepting input from a second user.

18. A system for analyzing a plurality of courses of action, comprising:
means for determining a set of decision parameters corresponding to a plurality of decision factors for each of the plurality of courses of action;
means for selecting an associated global influence value for each of the plurality of decision factors, the means for selecting allowing the associated influence values to be adjusted in real time;
means for calculating a fitness parameter for each course of action based upon the selected decision values and their associated global influence values;
means for displaying the calculated fitness parameters; and
means for updating the calculated fitness parameter at the means for displaying in real time according to input from the means for selecting.

19. The system of claim 18, further comprising means for recording adjustments to the influence values.

20. The system of claim 18, wherein the means for determining, the means for selecting, and the means for displaying are distributed, such that they can be accessed simultaneously by multiple users of the system.

21. The system of claim 18, wherein the means for determining a plurality of decision parameters includes means for accepting input from a user.

22. The system of claim 18, wherein the means for determining a plurality of decision parameters includes means for calculating a decision parameter for a course of action from a plurality of parameters associated with tasks within the course of action.
